(19) United States
(12) Patent Application Publication
(10) Pub. No.: US 2024/0007234 A1
(43) Pub. Date: Jan. 4, 2024

(54) METHOD AND APPARATUS FOR DISTRIBUTING TRAFFIC CHANNELS OVER A PHYSICAL INTERCONNECT

(71) Applicant: Ampere Computing LLC, Santa Clara, CA (US)

(72) Inventors: Ezra HARRINGTON, Beaverton, OR (US); Stephan JOURDAN, Portland, OR (US); Brian CHASE, Campbell, CA (US)

(21) Appl. No.: 17/810,261

(22) Filed: Jun. 30, 2022

(51) Int. Cl. H04L 5/00; H04L 69/18; H04L 69/22

(52) U.S. Cl. CPC H04L 5/0003; H04L 69/18; H04L 69/22

(57) ABSTRACT

Disclosed is die-to-die (D2D) interconnect of a component die. In an aspect, the D2D interconnect includes a transmit selection circuit, a plurality of transmit gearboxes (Tx GBXs), and a plurality of transmit D2D physical layer interfaces. The transmit selection circuit may be configured to receive at least two traffic channels and to output a data stream of at least one traffic channel to the plurality of Tx GBXs. Each of a subset of Tx GBXs may be configured to receive at least a portion of the data stream from the transmit selection circuit and to output at least the portion of the data stream to a transmit D2D physical layer interface to which the Tx GBX is communicatively coupled. Each transmit D2D physical layer interface coupled to the subset of Tx GBXs may be configured to output at least the portion of the data stream.

### BACKGROUND OF THE DISCLOSURE

### 1. Field of the Disclosure

Aspects of the disclosure relate generally to die-to-die interconnects, and specifically to transmitting multiple traffic channels of different protocols across a die-to-die interconnect.

### 2. Description of the Related Art

More and more data are being generated by more and more devices, increasing the cost and complexity of processing that data (e.g., in terms of energy, bandwidth, memory, processing, storage, etc.) in a central location, such as a monolithic system-on-chip (SoC). One approach to address this issue is to disaggregate the functionality of the SoC into multiple component dies (e.g., chiplets). A component die is an integrated circuit (IC) that includes a well-defined subset of functionality and that can be assembled with other component dies into a larger package. The concept behind disaggregated SoC is to have a library of component dies, each having its own dedicated functionality, such as memory, input/outputs (I/Os), analog functions, processing cores, etc. A specific set of component dies can then be assembled into a package and connected to each other using die-to-die (D2D) interconnects.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a die-to-die (D2D) interconnect of a first component die includes a transmit selection circuit; a plurality of transmit gearboxes (Tx GBXs) communicatively coupled to the transmit selection circuit; and a plurality of transmit D2D physical layer interfaces communicatively coupled to the plurality of Tx GBXs, wherein: the transmit selection circuit is configured to receive at least two traffic channels configured according to at least two different traffic channel protocols and to output a data stream of at least one traffic channel of the at least two traffic channels to the plurality of Tx GBXs, each of a subset of Tx GBXs of the plurality of Tx GBXs is configured to receive at least a portion of the data stream from the transmit selection circuit and to output at least the portion of the data stream to a transmit D2D physical layer interface of the plurality of transmit D2D physical layer interfaces to which the Tx GBX is communicatively coupled, and each transmit D2D physical layer interface of the plurality of transmit D2D physical layer interfaces coupled to the subset of Tx GBXs is configured to output at least the portion of the data stream received from the corresponding Tx GBX.

In an aspect, a die-to-die (D2D) interconnect of a first component die includes a plurality of receive D2D physical layer interfaces; a plurality of receive gearboxes (Rx GBXs) communicatively coupled to the plurality of receive D2D physical layer interfaces; and a receive selection circuit communicatively coupled to the plurality of Rx GBXs, wherein: each of a subset of receive D2D physical layer interfaces of the plurality of receive D2D physical layer interfaces is configured to receive at least a portion of a plurality of portions of one or more traffic channels and to output the received portion of the plurality of portions of the one or more traffic channels to an Rx GBX of the plurality of Rx GBXs to which the receive D2D physical layer interface is communicatively coupled, each Rx GBX of the plurality of Rx GBXs coupled to the subset of Rx D2D physical layer interfaces is configured to receive at least a portion of the plurality of portions of the one or more traffic channels from a receive D2D physical layer interface of the subset of receive D2D physical layer interfaces to which the Rx GBX is communicatively coupled and to output the received portion of the plurality of portions of the one or more traffic channels to the receive selection circuit, and the receive selection circuit is configured to receive the plurality of portions of the one or more traffic channels from the plurality of Rx GBXs and to output the one or more traffic channels.

In an aspect, a die-to-die (D2D) interconnect of a first component die includes a transmit selection circuit; a receive selection circuit; a plurality of transmit gearboxes (Tx GBXs) communicatively coupled to the transmit selection circuit; a plurality of receive gearboxes (Rx GBXs) communicatively coupled to the receive selection circuit; a plurality of transmit D2D physical layer interfaces communicatively coupled to the plurality of Tx GBXs; and a plurality of receive D2D physical layer interfaces communicatively coupled to the plurality of Rx GBXs, wherein: the transmit selection circuit is configured to receive at least two traffic channels configured according to at least two different traffic channel protocols and to output a data stream of at least one traffic channel of the at least two traffic channels to the plurality of Tx GBXs, each of a subset of Tx GBXs of the plurality of Tx GBXs is configured to receive a portion of the data stream from the transmit selection circuit and to output at least the portion of the data stream to a transmit D2D physical layer interface of the plurality of transmit D2D physical layer interfaces to which the Tx GBX is communicatively coupled, each transmit D2D physical layer interface of the plurality of transmit D2D physical layer interfaces coupled to the subset of Tx GBXs is configured to output at least the portion of the data stream received from the corresponding Tx GBX, each of a subset of receive D2D physical layer interfaces of the plurality of receive D2D physical layer interfaces is configured to receive at least a portion of a plurality of portions of one or more traffic channels of the at least two traffic channels and to output the received portion of the plurality of portions of the one or more traffic channels to an Rx GBX of the plurality of Rx GBXs to which the receive D2D physical layer interface is communicatively coupled, each Rx GBX of the plurality of Rx GBXs coupled to the subset of receive D2D physical layer interfaces is configured to receive at least a portion of the plurality of portions of the one or more traffic channels from a receive D2D physical layer interface of the subset of receive D2D physical layer interfaces to which the Rx GBX is communicatively coupled and to output the received portion of the plurality of portions of the one or more traffic channels to the receive selection circuit, and the receive selection circuit is configured to receive the plurality of portions of the one or more traffic channels from the plurality of Rx GBXs and to output the one or more traffic channels.

In an aspect, a method of operating a die-to-die (D2D) interconnect of a first component die includes receiving, at a transmit selection circuit of the D2D interconnect, at least two traffic channels configured according to at least two different traffic channel protocols and outputting a data stream of at least one traffic channel of the at least two traffic channels to a plurality of transmit gearboxes (Tx GBXs) of the D2D interconnect; receiving, at each of a subset of Tx GBXs of the plurality of Tx GBXs, at least a portion of the data stream from the transmit selection circuit and outputting at least the portion of the data stream to a transmit D2D physical layer interface of a plurality of transmit D2D physical layer interfaces of the D2D interconnect to which the Tx GBX is communicatively coupled; and outputting, by each transmit D2D physical layer interface of the plurality of transmit D2D physical layer interfaces coupled to the subset of Tx GBXs, at least the portion of the data stream received from the corresponding Tx GBX.

In an aspect, a method of operating a die-to-die (D2D) interconnect of a first component die includes receiving, at each of a subset of receive D2D physical layer interfaces of a plurality of receive D2D physical layer interfaces of the D2D interconnect, at least a portion of a plurality of portions of one or more traffic channels and outputting the received portion of the plurality of portions of the one or more traffic channels to a receive gearbox (Rx GBX) of a plurality of Rx GBXs to which the receive D2D physical layer interface is communicatively coupled; receiving, at each Rx GBX of the plurality of Rx GBXs coupled to the subset of receive D2D physical layer interfaces, at least a portion of the plurality of portions of the one or more traffic channels from a receive D2D physical layer interface of the subset of receive D2D physical layer interfaces to which the Rx GBX is communicatively coupled and outputting the received portion of the plurality of portions of the one or more traffic channels to the receive selection circuit; and receiving, at the receive selection circuit, the plurality of portions of the one or more traffic channels from the plurality of Rx GBXs and outputting the one or more traffic channels.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a diagram illustrating an example of a disaggregated system-on-chip (SoC), according to aspects of the disclosure.

FIG. 2 is a diagram illustrating an example architecture of two die-to-die (D2D) interconnects, according to aspects of the disclosure.

FIG. 3 illustrates an example method of operating the transmit portion of a D2D interconnect of a first component die, according to aspects of the disclosure.

FIG. 4 illustrates an example method of operating the receive portion of a D2D interconnect of a first component die, according to aspects of the disclosure.

FIG. 5 illustrates examples of different header formats for different traffic channel protocols, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

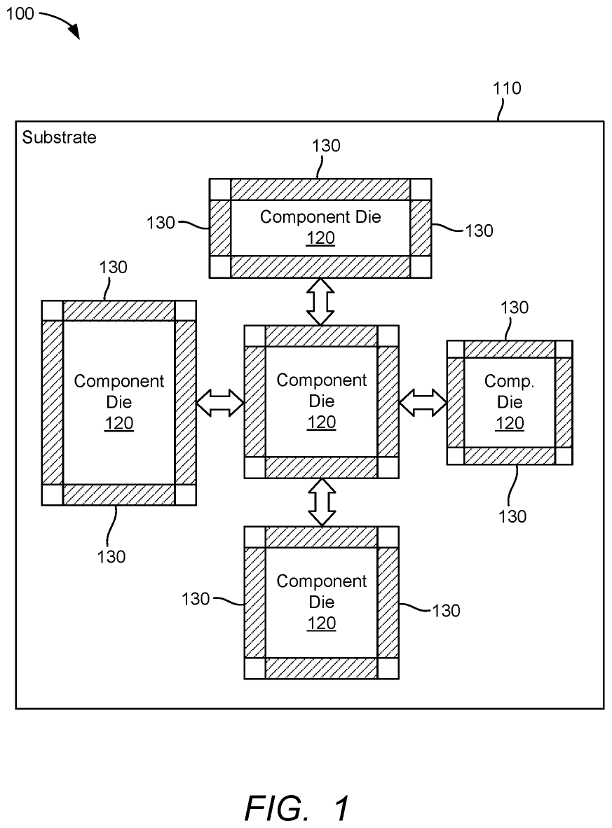

FIG. 1 is a diagram 100 illustrating an example of a disaggregated system-on-chip (SoC), according to aspects of the disclosure. In the example of FIG. 1, five component dies 120 are mounted on a substrate 110 and form a disaggregated SoC. As noted above, a component die (e.g., a chiplet) is an integrated circuit (IC) that includes a well-defined subset of functionality and that can be assembled with other component dies 120 into a larger package (e.g., a disaggregated SoC). Each component die 120 may provide a specific function, such as memory access, I/O, an analog function, a processing core, etc. A common configuration includes a main component die 120, which may be a compute component die, that communicates with other component dies 120, which may be other compute component dies or component dies that provide I/O, memory, or other peripheral functions. As will be appreciated, although FIG. 1 illustrates five component dies 120, there may be more or fewer than five component dies 120 mounted to the substrate 110. In addition, the component dies 120 may be different sizes and shapes and manufactured by different vendors.

Each component die 120 has a die-to-die (D2D) interconnect 130 on each edge, indicated by the hashed blocks. In the example of FIG. 1, only the central chiplet 120 (e.g., the main component die 120) is connected on all four sides to other component dies 120, but all five component dies 120 have four D2D interconnects 130. This allows for greater modularity and flexibility in the use of each component die 120 and the layout of the component dies 120 on the substrate 110. However, as will be appreciated, not every component die 120 must have a D2D interconnect 130 on each side; rather, a component die 120 may have D2D interconnects 130 on only one, two, or three sides, or as many interconnects as area and other constraints permit.

SoC disaggregation can enable a high core count (as there is no need to fit the entire SoC inside the reticle), provide cost benefits (e.g., different dies may be on different processes, not everything needs to be on the lead process), and decrease the time to market (e.g., SoCs may be built with some previous generation component dies). To support SoC disaggregation, it is important to be able to transport many different types of traffic (e.g., memory, I/O, configurations, interrupts, etc.) between component dies. Examples of different traffic that may need to be transported between component dies include Coherent Hub Interconnect (CHI) Request, Response, Snoop, and Data channels, Advanced eXtensible Interface (AXI) channels, AXI4-Stream channels, and other protocols, such as interrupts, four-phase handshake signals, bus traffic, and the like. A D2D interconnect 130 should enable all the various traffic types to utilize the physical D2D resources effectively. For example, a D2D interconnect 130 should provide a low latency, high bandwidth, low overhead interface that prioritizes traffic appropriately.

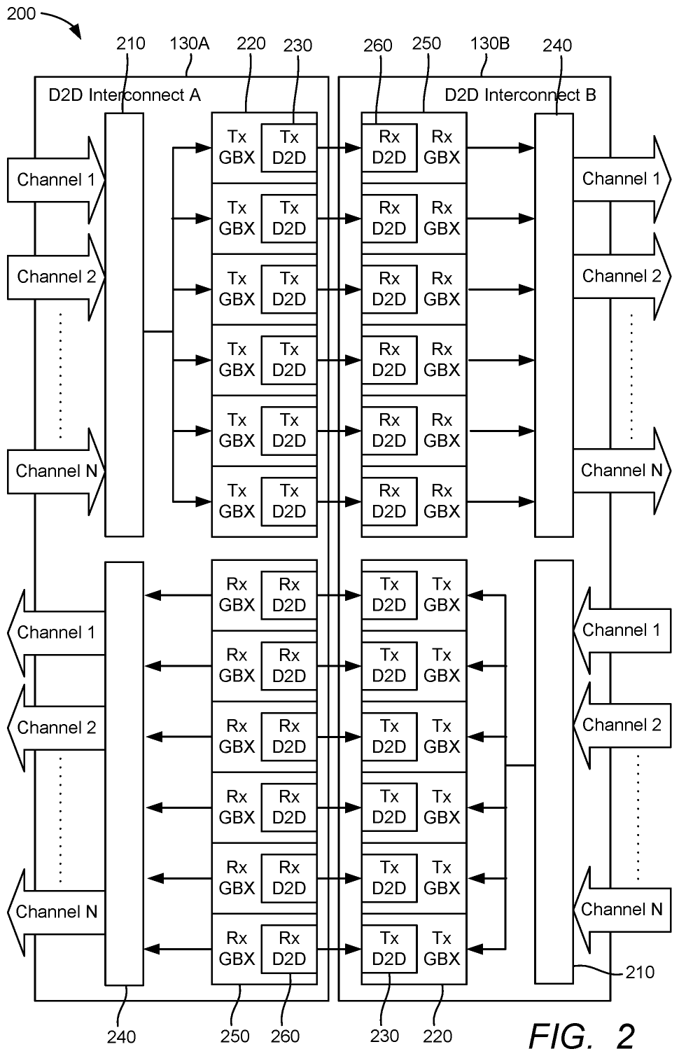

FIG. 2 is a diagram 200 illustrating an example architecture of two D2D interconnects, according to aspects of the disclosure. As shown in FIG. 2, a first D2D interconnect 130A (labeled “D2D Interconnect A”) includes a selection circuit 210 (e.g., a multiplexer, a scheduler, or the like) and six transmit gearboxes (Tx GBXs) 220, with each Tx GBX 220 including or coupled to a Tx D2D physical layer interface 230. D2D interconnect 130A further includes a receive selection circuit 240 (e.g., a multiplexer, a scheduler, or the like) and six receive gearboxes (Rx GBXs) 250, with each Rx GBX 250 including or coupled to an Rx D2D physical layer interface 260. As will be appreciated, there may be more or fewer than six Tx GBXs 220 and more or fewer than six Rx GBXs 250 in D2D interconnect 130A.

Similarly, a second D2D interconnect 130B (labeled “D2D Interconnect B”) includes a receive selection circuit 240 and six Rx GBXs 250, with each Rx GBX 250 including or coupled to an Rx D2D physical layer interface 260. D2D interconnect 130B further includes a selection circuit 210 and six Tx GBXs 220, with each Tx GBX 220 including or coupled to a Tx D2D physical layer interface 230. As will be appreciated, there may be more or fewer than six Rx GBXs 250 and more or fewer than six Tx GBXs 220 in D2D interconnect 130B.

In an example implementation, the input size of each Tx GBX 220 may be 178 bits and the output size may be 192 bits. Conversely, the input size of each Rx GBX 250 may be 192 bits and the output size may be 178 bits. The 14 bits added by the Tx GBXs 220 and removed by the Rx GBXs 250 may be configured for error correction and coordination among the Tx and Rx GBXs 250. In an example implementation, the 14 bits may include up to 10 bits for error correction (e.g., cyclic redundancy check (CRC) bits) and up to 4 bits for coordination among the plurality of Tx GBXs 220 and Rx GBXs 250 (e.g., acknowledgments (ACKs) and negative acknowledgments (NACKs)). In addition, in an example implementation, the output size of the Tx D2D physical layer interfaces 230 and the input size of the Rx D2D physical layer interfaces 260 may be seven bits. As such, a Tx D2D physical layer interface may 230 transmit the 192 bits received from the Tx GBX 220 in 28 cycles/pulses. As will be appreciated, the specific bit widths disclosed above are matters of engineering design choice, and those having skill in the art can adapt this specific example to their specific system and physical layer.

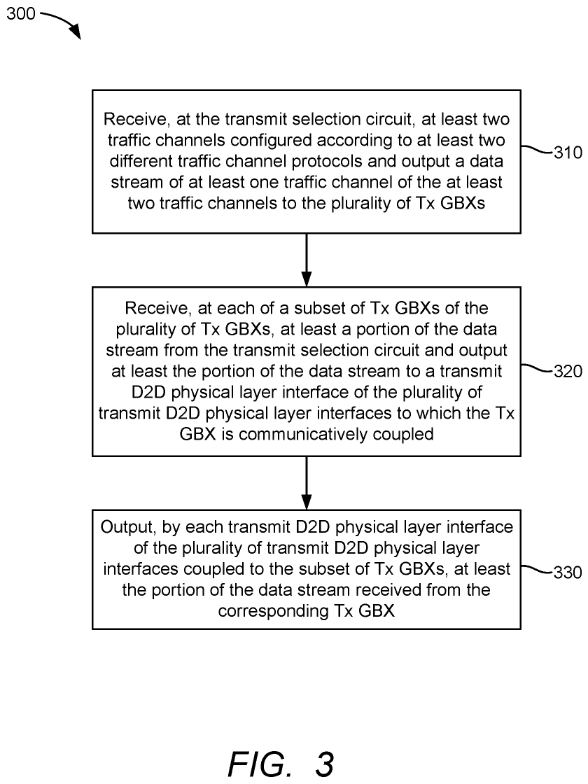

FIG. 3 illustrates an example method 300 of operating the transmit portion of a D2D interconnect 130 of a first component die 120, according to aspects of the disclosure.

At 310, the transmit selection circuit 210 receives (e.g., from other circuitry of the first component die 120) data for at least two traffic channels (e.g., to be transmitted from the first component die 120 to a second component die 120) configured according to at least two different traffic channel protocols, and outputs a data stream of at least one traffic channel of the at least two traffic channels to a plurality of Tx GBXs 220. More specifically, the transmit selection circuit 210 divides the incoming traffic channels into a plurality of portions and routes the plurality of portions to the plurality of Tx GBXs 220.

The data stream of the at least one traffic channel may comprise one traffic channel of the at least two traffic channels or multiple interleaved traffic channels of the at least two traffic channels. For example, where the input size of each Tx GBX 220 is 178 bits, the transmit selection circuit 210 may output a first 178-bit portion of a traffic channel to a first Tx GBX 220, a second 178-bit portion of the traffic channel to a second Tx GBX 220, a third 178-bit portion of the traffic channel to a third Tx GBX 220, and so on until there is no longer any data of the traffic channel to send, until a higher priority channel is received, until some threshold number of 178-bit portions of the traffic channel have been output, or some other criteria is satisfied. As another example, the transmit selection circuit 210 may output a 178-bit portion of a first traffic channel to a first Tx GBX 220, a 178-bit portion of a second traffic channel to a second Tx GBX 220, a 178-bit portion of a third traffic channel to a third Tx GBX 220, and so on, thereby interleaving multiple traffic channels.

The transmit selection circuit 210 may be configured to add header information to each portion of the data stream output to the plurality of Tx GBXs 220. As described further below, the header information may have a variable length based on a traffic channel protocol associated with the portion of the data stream to which the header is added.

At 320, each of a subset of Tx GBXs 220 of the plurality of Tx GBXs 220 receives at least a portion (e.g., a 178-bit portion) of the data stream from the transmit selection circuit 210 and outputs at least the portion of the data stream to a Tx D2D physical layer interface 230 of the plurality of Tx D2D physical layer interfaces 230 to which the Tx GBX 220 is communicatively coupled. Each of the subset of Tx GBXs 220 may additionally output error correction information (e.g., CRC bits) for its portion of the data stream and control information for coordination among the plurality of Tx GBXs 220 and Rx GBXs 250. For example, where the input size of each Tx GBX 220 is 178 bits and the output size is 192 bits, each Tx GBX 220 may add up to 14 bits of error correction information and control information to the received portion of the data stream.

Different combinations and numbers of traffic channel protocols and traffic channel types are possible. In addition, different traffic channels may have different priorities and/or different requirements regarding their latency and bandwidth. In an aspect, certain high-bandwidth traffic can be prioritized by assigning them to dedicated D2D resources (e.g., GBXs and the associated D2D physical layer interfaces) and/or throttling low-bandwidth traffic that shares the same D2D resources. As such, a first subset (e.g., the four outside Tx GBXs 220 in FIG. 2) of the plurality of Tx GBXs 220 may be dedicated to one or more traffic channel protocols of the at least two traffic channels while a second subset (e.g., the two inside Tx GBXs 220 in FIG. 2) of the plurality of Tx GBXs 220 may be configurable for different traffic channel protocols of the at least two traffic channels. The first subset of the plurality of Tx GBXs 220 may be dedicated to the one or more traffic channel protocols based on priorities of the one or more traffic channel protocols, latency requirements of the one or more traffic channel protocols, bandwidth requirements of the one or more traffic channel protocols, or any combination thereof. Similarly, the second subset of the plurality of Tx GBXs 220 may be configurable for the different traffic channel protocols based on priorities of the different traffic channel protocols, latency requirements of the different traffic channel protocols, bandwidth requirements of the different traffic channel protocols, or any combination thereof. For example, data channels may have higher priority, lower latency requirements, and/or higher bandwidth requirements than other traffic channel protocols, and therefore, the first subset of the plurality of Tx GBXs 220 may be dedicated to data channels. By dedicating the first subset of the plurality of Tx GBXs 220 to data channels, no other traffic channel protocols are transmitted on those D2D resources so there is less contention for those resources. In contrast, non-data channels may have lower priority, higher latency tolerance, and/or lower bandwidth requirements than data channels, and therefore, may share the second subset of Tx GBXs 220.

Note that that having “dedicated” Tx GBXs 220 does not imply that the “dedicated” Tx GBXs 220 must service only one type of traffic channel. For example, if there are two types of traffic channels that are high priority and four that are lower priority, four Tx GBXs 220 may be dedicated to the two high priority traffic channel types and the remaining two Tx GBXs 220 may be freely arbitrated between all six types of traffic channels. In addition, whether and which subset of Tx GBXs 220 is “dedicated” to certain traffic types and whether and which subset of Tx GBXs 220 is freely arbitrated between all traffic types are configurable, and may change based on the specific application.

Various D2D physical layer resource sharing rules/heuristics can be used to determine how to assign different traffic channels to different Tx GBXs 220 or different subsets of Tx GBXs 220. These D2D resource sharing rules/algorithms may be altered to fit specific traffic channel scenarios (e.g., number of traffic channels, types of traffic channels, etc.). For example, the physical slot assignments (i.e., which Tx GBX 220 a traffic channel may be assigned to) and/or the temporal slot assignments (i.e., how often a traffic channel may be transmitted by a Tx GBX 220, e.g., once every N cycles) may be configured/updated based on the specific scenarios. This results in lower latency, because the arbitration decisions of where to assign the incoming traffic channels are faster, and higher bandwidth, because it results in lower signaling/control overhead as there is very little header information that needs to be included with each portion of the traffic channel.

At 330, each Tx D2D physical layer interface 230 of the plurality of Tx D2D physical layer interfaces 230 coupled to the subset of Tx GBXs 220 outputs at least the portion of the data stream (e.g., to an Rx D2D physical layer interface 260 of the second component die 120) received from the corresponding Tx GBX 220.

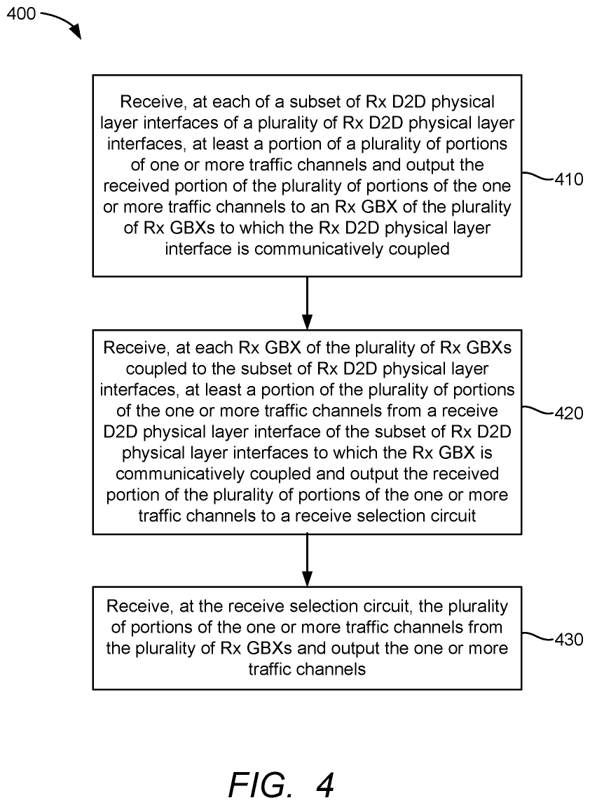

FIG. 4 illustrates an example method 400 of operating the receive portion of a D2D interconnect 130 of a first component die 120, according to aspects of the disclosure.

At 410, each of a subset of Rx D2D physical layer interfaces 260 of a plurality of Rx D2D physical layer interfaces 260 of the D2D interconnect 130 receives (e.g., from a Tx D2D physical layer interface 230 of a second component die 120) at least a portion of a plurality of portions of one or more traffic channels, and outputs the received portion of the plurality of portions of the one or more traffic channels to an Rx GBX 250 of a plurality of Rx GBXs 250 to which the Rx D2D physical layer interface 260 is communicatively coupled. As described above, the one or more traffic channels may be one traffic channel or multiple interleaved traffic channels of a plurality of traffic channels.

At 420, each Rx GBX 250 of the plurality of Rx GBXs 250 coupled to the subset of Rx D2D physical layer interfaces 260 receives at least a portion of the plurality of portions of the one or more traffic channels from an Rx D2D physical layer interface 260 of the subset of Rx D2D physical layer interfaces 260 to which the Rx GBX 250 is communicatively coupled, and outputs the received portion of the plurality of portions of the one or more traffic channels to the receive selection circuit 240. As described above, each portion of the plurality of portions of the one or more traffic channels may include error correction information (e.g., CRC bits) and control information. For example, where the input size of each Tx GBX 220 is 178 bits and the output size is 192 bits, each portion of the plurality of portions of the one or more traffic channels may include up to 14 bits of error correction information and control information. Each Rx GBX 250 may use the error correction information to determine whether the received portion of the plurality of portions of the one or more traffic channels was received correctly and provide the appropriate feedback (e.g., ACK/NACK) via the control information bits. Each Rx GBX 250 may then output only the 178-bit portion of the plurality of portions of the one or more traffic channels.

In an aspect, a first subset (e.g., the four outside Rx GBXs 250 in FIG. 2) of the plurality of Rx GBXs 250 may be dedicated to one or more traffic channel protocols of the plurality of traffic channels while a second subset (e.g., the two inside Rx GBXs 250 in FIG. 2) of the plurality of Rx GBXs 250 may be configurable for different traffic channel protocols of the plurality of traffic channels. This would be the same configuration as for the plurality of Tx GBXs 220, as there is a one-to-one correspondence between the plurality of Tx GBXs 220 and the plurality of Rx GBXs 250.

At 430, the receive selection circuit 240 receives the plurality of portions of the one or more traffic channels from the plurality of Rx GBXs 250, reassembles them into the one or more traffic channels, and outputs the one or more traffic channels (e.g., to other circuitry of the first component die 120). Note that, depending on how the one or more traffic channels were split up across the Tx GBXs 220 on the transmitter side, it may take multiple cycles to reassemble a traffic channel message on the receiver side. The receive selection circuit 240 may be configured to remove the header information from each portion of the plurality of portions of the one or more traffic channels. Alternatively, the header information may remain to be used by other circuitry of the first component die 120.

Referring to the header information of each portion of the plurality of portions of the data stream in greater detail, the transmit selection circuit 210 should be configured to add enough header information to each portion of the traffic channel regarding the traffic channel protocol of the traffic channel that the portion can be disambiguated on the receiver side (e.g., D2D interconnect 130B). The present disclosure uses “hierarchical” headers to send less header information for “larger” protocol traffic that is more resource intensive (e.g., data channels).

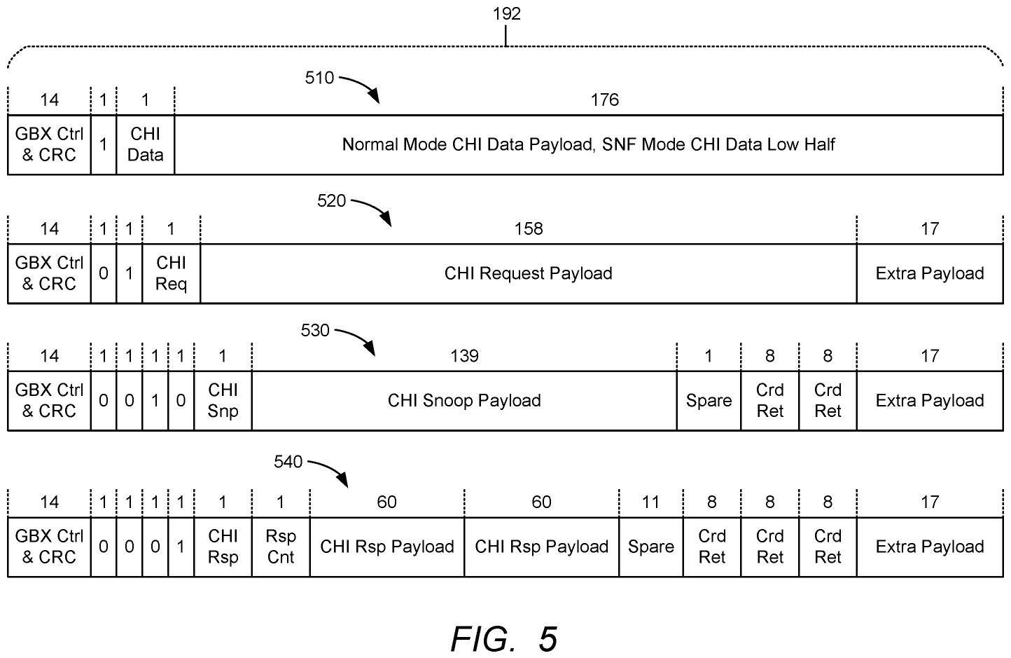

FIG. 5 illustrates examples of different header formats for different traffic channel protocols, according to aspects of the disclosure. Specifically, FIG. 5 illustrates the format of four different traffic channel protocols output by a Tx GBX 220 or received by an Rx GBX 250 in 192-bit portions. In the example of FIG. 5, the first 14 bits of each 192-bit traffic channel portion is used for GBX control and error correction information (labeled “GBX Ctrl & CRC”). The first 192-bit traffic channel protocol format 510 illustrated in FIG. 5 is for CHI data, the second 192-bit traffic channel protocol format 520 is for a CHI request, the third 192-bit traffic channel protocol format 530 is for a CHI snoop, and the fourth 192-bit traffic channel protocol format 540 is for a CHI response.

As shown by the examples in FIG. 5, the headers for larger, higher priority, higher bandwidth protocol traffic that is more resource intensive (e.g., CHI data) are relatively fewer bits than the headers for smaller, lower priority, lower bandwidth protocol traffic that is less resource intensive. For example, values of “1” in the two most-significant bits after the 14-bit field for the GBX control and error correction information indicate CHI data and allow for 176 bits for the CHI data payload. As another example, values of “0,” “1,” and “1” in the three most-significant bits after the 14-bit field indicate a CHI request and allows for 158 bits for the CHI request payload. As yet another example, values of “0” in the first two most-significant bits indicate that the header has four bits of metadata, and the third and fourth most-significant bits after the 14-bit field for the GBX control and error correction information indicates whether the traffic channel protocol is a CHI snoop or a CHI response.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A die-to-die (D2D) interconnect of a first component die, comprising:
a transmit selection circuit;
a plurality of transmit gearboxes (Tx GBXs) communicatively coupled to the transmit selection circuit; and
a plurality of transmit D2D physical layer interfaces communicatively coupled to the plurality of Tx GBXs, wherein:
the transmit selection circuit is configured to receive at least two traffic channels configured according to at least two different traffic channel protocols and to output a data stream of at least one traffic channel of the at least two traffic channels to the plurality of Tx GBXs,
each of a subset of Tx GBXs of the plurality of Tx GBXs is configured to receive at least a portion of the data stream from the transmit selection circuit and to output at least the portion of the data stream to a transmit D2D physical layer interface of the plurality of transmit D2D physical layer interfaces to which the Tx GBX is communicatively coupled, and
each transmit D2D physical layer interface of the plurality of transmit D2D physical layer interfaces coupled to the subset of Tx GBXs is configured to output at least the portion of the data stream received from the corresponding Tx GBX.

2. The D2D interconnect of claim 1, wherein:
each of the subset of Tx GBX of the plurality of Tx GBXs being configured to output at least the portion of the data stream comprises each of the subset of Tx GBXs of the plurality of Tx GBXs being configured to output the portion of the data stream, error correction information for the portion of the data stream, and control information for coordination among the plurality of Tx GBXs.

3. The D2D interconnect of claim 1, wherein the data stream of the at least one traffic channel comprises:
one traffic channel of the at least two traffic channels, or
multiple interleaved traffic channels of the at least two traffic channels.

4. The D2D interconnect of claim 1, wherein:
a first subset of the plurality of Tx GBXs is dedicated to one or more traffic channel protocols of the at least two traffic channels, and
a second subset of the plurality of Tx GBXs is configurable for different traffic channel protocols of the at least two traffic channels.

5. The D2D interconnect of claim 4, wherein:
the first subset of the plurality of Tx GBXs is dedicated to the one or more traffic channel protocols based on priorities of the one or more traffic channel protocols, latency requirements of the one or more traffic channel protocols, bandwidth requirements of the one or more traffic channel protocols, or any combination thereof, and
the second subset of the plurality of Tx GBXs is configurable for the different traffic channel protocols based on priorities of the different traffic channel protocols, latency requirements of the different traffic channel protocols, bandwidth requirements of the different traffic channel protocols, or any combination thereof.

6. The D2D interconnect of claim 1, wherein:
each portion of the data stream includes header information, and
the header information has a variable length based on a traffic channel protocol associated with the portion of the data stream.

7. The D2D interconnect of claim 6, wherein the transmit selection circuit is configured to add the header information to each portion of the data stream.

8. The D2D interconnect of claim 6, wherein:
the header information occupies fewer bits of the portion of the data stream based on the traffic channel protocol being a higher bandwidth channel protocol and more bits based on the traffic channel protocol being a lower bandwidth channel protocol.

9. The D2D interconnect of claim 1, wherein:
the at least two traffic channels are to be transmitted to a second component die, and
each transmit D2D physical layer interface of the plurality of transmit D2D physical layer interfaces is configured to output at least the portion of the data stream to a receive D2D physical layer interface on the second component die.

10. The D2D interconnect of claim 1, further comprising:
a plurality of receive D2D physical layer interfaces;
a plurality of receive gearboxes (Rx GBXs) communicatively coupled to the plurality of receive D2D physical layer interfaces; and
a receive selection circuit communicatively coupled to the plurality of Rx GBXs, wherein:
each of a subset of receive D2D physical layer interfaces of the plurality of receive D2D physical layer interfaces is configured to receive at least a portion of a plurality of portions of one or more traffic channels of the at least two traffic channels and to output the received portion of the plurality of portions of the one or more traffic channels to an Rx GBX of the plurality of Rx GBXs to which the receive D2D physical layer interface is communicatively coupled,
each Rx GBX of the plurality of Rx GBXs coupled to the subset of the receive D2D physical layer interfaces is configured to receive at least a portion of the plurality of portions of the one or more traffic channels from a receive D2D physical layer interface of the subset of receive D2D physical layer interfaces to which the Rx GBX is communicatively coupled and to output the received portion of the plurality of portions of the one or more traffic channels to the receive selection circuit, and
the receive selection circuit is configured to receive the plurality of portions of the one or more traffic channels from the plurality of Rx GBXs and to output the one or more traffic channels.

11. A die-to-die (D2D) interconnect of a first component die, comprising:
a plurality of receive D2D physical layer interfaces;
a plurality of receive gearboxes (Rx GBXs) communicatively coupled to the plurality of receive D2D physical layer interfaces; and
a receive selection circuit communicatively coupled to the plurality of Rx GBXs, wherein:
each of a subset of receive D2D physical layer interfaces of the plurality of receive D2D physical layer interfaces is configured to receive at least a portion of a plurality of portions of one or more traffic channels and to output the received portion of the plurality of portions of the one or more traffic channels to an Rx GBX of the plurality of Rx GBXs to which the receive D2D physical layer interface is communicatively coupled,
each Rx GBX of the plurality of Rx GBXs coupled to the subset of receive D2D physical layer interfaces is configured to receive at least a portion of the plurality of portions of the one or more traffic channels from a receive D2D physical layer interface of the subset of receive D2D physical layer interfaces to which the Rx GBX is communicatively coupled and to output the received portion of the plurality of portions of the one or more traffic channels to the receive selection circuit, and
the receive selection circuit is configured to receive the plurality of portions of the one or more traffic channels from the plurality of Rx GBXs and to output the one or more traffic channels.

12. The D2D interconnect of claim 11, wherein:
each Rx GBX of the plurality of Rx GBXs being configured to receive at least the portion of the plurality of portions of the one or more traffic channels comprises each Rx GBX of the plurality of Rx GBXs being configured to receive the portion of the plurality of portions of the one or more traffic channels, error correction information for the portion of the plurality of portions of the one or more traffic channels, and control information for coordination among the plurality of Rx GBXs.

13. The D2D interconnect of claim 11, wherein the one or more traffic channels comprises:
one traffic channel, or
multiple interleaved traffic channels of a plurality of traffic channels.

14. The D2D interconnect of claim 11, wherein:
a first subset of the plurality of Rx GBXs is dedicated to one or more traffic channel protocols of the one or more traffic channels, and
a second subset of the plurality of Rx GBXs is configurable for different traffic channel protocols of the one or more traffic channels.

15. The D2D interconnect of claim 14, wherein:
the first subset of the plurality of Rx GBXs is dedicated to the one or more traffic channel protocols based on priorities of the one or more traffic channel protocols, latency requirements of the one or more traffic channel protocols, bandwidth requirements of the one or more traffic channel protocols, or any combination thereof, and
the second subset of the plurality of Rx GBXs is configurable for the different traffic channel protocols based on priorities of the different traffic channel protocols, latency requirements of the different traffic channel protocols, bandwidth requirements of the different traffic channel protocols, or any combination thereof.

16. The D2D interconnect of claim 11, wherein:
each portion of the plurality of portions of the one or more traffic channels includes header information, and
the header information has a variable length based on a traffic channel protocol associated with the portion of the plurality of portions of the one or more traffic channels.

17. The D2D interconnect of claim 16, wherein:
the header information occupies fewer bits of the portion of the plurality of portions of the one or more traffic channels based on the traffic channel protocol being a higher bandwidth channel protocol and more bits based on the traffic channel protocol being a lower bandwidth channel protocol.

18. The D2D interconnect of claim 11, wherein each of the subset of receive D2D physical layer interfaces of the plurality of receive D2D physical layer interfaces is configured to receive at least the portion of the plurality of portions of the one or more traffic channels from a transmit D2D physical layer interface of a second component die.

19. The D2D interconnect of claim 11, further comprising:
a transmit selection circuit;
a plurality of transmit gearboxes (Tx GBXs) communicatively coupled to the transmit selection circuit; and
a plurality of transmit D2D physical layer interfaces communicatively coupled to the plurality of Tx GBXs, wherein:
the transmit selection circuit is configured to receive at least two traffic channels configured according to at least two different traffic channel protocols and to output a data stream of at least one traffic channel of the at least two traffic channels to the plurality of Tx GBXs,
each of a subset of Tx GBXs of the plurality of Tx GBXs is configured to receive a portion of the data stream from the transmit selection circuit and to output at least the portion of the data stream to a transmit D2D physical layer interface of the plurality of transmit D2D physical layer interfaces to which the Tx GBX is communicatively coupled, and
each transmit D2D physical layer interface of the plurality of transmit D2D physical layer interfaces coupled to the subset of Tx GBXs is configured to output at least the portion of the data stream received from the corresponding Tx GBX.

20. A die-to-die (D2D) interconnect of a first component die, comprising:
a transmit selection circuit;
a receive selection circuit;
a plurality of transmit gearboxes (Tx GBXs) communicatively coupled to the transmit selection circuit;
a plurality of receive gearboxes (Rx GBXs) communicatively coupled to the receive selection circuit;
a plurality of transmit D2D physical layer interfaces communicatively coupled to the plurality of Tx GBXs; and
a plurality of receive D2D physical layer interfaces communicatively coupled to the plurality of Rx GBXs, wherein:
the transmit selection circuit is configured to receive at least two traffic channels configured according to at least two different traffic channel protocols and to output a data stream of at least one traffic channel of the at least two traffic channels to the plurality of Tx GBXs,
each of a subset of Tx GBXs of the plurality of Tx GBXs is configured to receive a portion of the data stream from the transmit selection circuit and to output at least the portion of the data stream to a transmit D2D physical layer interface of the plurality of transmit D2D physical layer interfaces to which the Tx GBX is communicatively coupled,
each transmit D2D physical layer interface of the plurality of transmit D2D physical layer interfaces coupled to the subset of Tx GBXs is configured to output at least the portion of the data stream received from the corresponding Tx GBX,
each of a subset of receive D2D physical layer interfaces of the plurality of receive D2D physical layer interfaces is configured to receive at least a portion of a plurality of portions of one or more traffic channels of the at least two traffic channels and to output the received portion of the plurality of portions of the one or more traffic channels to an Rx GBX of the plurality of Rx GBXs to which the receive D2D physical layer interface is communicatively coupled,
each Rx GBX of the plurality of Rx GBXs coupled to the subset of receive D2D physical layer interfaces is configured to receive at least a portion of the plurality of portions of the one or more traffic channels from a receive D2D physical layer interface of the subset of receive D2D physical layer interfaces to which the Rx GBX is communicatively coupled and to output the received portion of the plurality of portions of the one or more traffic channels to the receive selection circuit, and
the receive selection circuit is configured to receive the plurality of portions of the one or more traffic channels from the plurality of Rx GBXs and to output the one or more traffic channels.

21. A method of operating a die-to-die (D2D) interconnect of a first component die, comprising:
receiving, at a transmit selection circuit of the D2D interconnect, at least two traffic channels configured according to at least two different traffic channel protocols and outputting a data stream of at least one traffic channel of the at least two traffic channels to a plurality of transmit gearboxes (Tx GBXs) of the D2D interconnect;
receiving, at each of a subset of Tx GBXs of the plurality of Tx GBXs, at least a portion of the data stream from the transmit selection circuit and outputting at least the portion of the data stream to a transmit D2D physical layer interface of a plurality of transmit D2D physical layer interfaces of the D2D interconnect to which the Tx GBX is communicatively coupled; and
outputting, by each transmit D2D physical layer interface of the plurality of transmit D2D physical layer interfaces coupled to the subset of Tx GBXs, at least the portion of the data stream received from the corresponding Tx GBX.

22. The method of claim 21, wherein outputting, by each of the subset of Tx GBXs of the plurality of Tx GBXs, at least the portion of the data stream comprises:
outputting, by each of the subset of Tx GBXs of the plurality of Tx GBXs, the portion of the data stream, error correction information for the portion of the data stream, and control information for coordination among the plurality of Tx GBXs.

23. The method of claim 21, wherein the data stream of the at least one traffic channel comprises:
one traffic channel of the at least two traffic channels, or
multiple interleaved traffic channels of the at least two traffic channels.

24. The method of claim 21, wherein:
a first subset of the plurality of Tx GBXs is dedicated to one or more traffic channel protocols of the at least two traffic channels, and
a second subset of the plurality of Tx GBXs is configurable for different traffic channel protocols of the at least two traffic channels.

25. The method of claim 24, wherein:
the first subset of the plurality of Tx GBXs is dedicated to the one or more traffic channel protocols based on priorities of the one or more traffic channel protocols, latency requirements of the one or more traffic channel protocols, bandwidth requirements of the one or more traffic channel protocols, or any combination thereof, and
the second subset of the plurality of Tx GBXs is configurable for the different traffic channel protocols based on priorities of the different traffic channel protocols, latency requirements of the different traffic channel protocols, bandwidth requirements of the different traffic channel protocols, or any combination thereof.

26. The method of claim 21, wherein:
each portion of the data stream includes header information, and
the header information has a variable length based on a traffic channel protocol associated with the portion of the data stream.

27. The method of claim 26, wherein the transmit selection circuit is configured to add the header information to each portion of the data stream.

28. The method of claim 26, wherein:
the header information occupies fewer bits of the portion of the data stream based on the traffic channel protocol being a higher bandwidth channel protocol and more bits based on the traffic channel protocol being a lower bandwidth channel protocol.

29. The method of claim 21, wherein:
the at least two traffic channels are to be transmitted to a second component die, and
each transmit D2D physical layer interface of the plurality of transmit D2D physical layer interfaces is configured to output at least the portion of the data stream to a receive D2D physical layer interface on the second component die.

30. A method of operating a die-to-die (D2D) interconnect of a first component die, comprising:
receiving, at each of a subset of receive D2D physical layer interfaces of a plurality of receive D2D physical layer interfaces of the D2D interconnect, at least a portion of a plurality of portions of one or more traffic channels and outputting the received portion of the plurality of portions of the one or more traffic channels to a receive gearbox (Rx GBX) of a plurality of Rx GBXs to which the receive D2D physical layer interface is communicatively coupled;
receiving, at each Rx GBX of the plurality of Rx GBXs coupled to the subset of receive D2D physical layer interfaces, at least a portion of the plurality of portions of the one or more traffic channels from a receive D2D physical layer interface of the subset of receive D2D physical layer interfaces to which the Rx GBX is communicatively coupled and outputting the received portion of the plurality of portions of the one or more traffic channels to the receive selection circuit; and
receiving, at the receive selection circuit, the plurality of portions of the one or more traffic channels from the plurality of Rx GBXs and outputting the one or more traffic channels.

31. The method of claim 30, wherein receiving, at each Rx GBX of the plurality of Rx GBXs coupled to the subset of receive D2D physical layer interfaces, at least the portion of the plurality of portions of the one or more traffic channels comprises:
receiving, at each Rx GBX of the plurality of Rx GBXs coupled to the subset of receive D2D physical layer interfaces, the portion of the plurality of portions of the one or more traffic channels, error correction information for the portion of the plurality of portions of the one or more traffic channels, and control information for coordination among the plurality of Rx GBXs.

32. The method of claim 30, wherein the one or more traffic channels comprises:
one traffic channel, or
multiple interleaved traffic channels of a plurality of traffic channels.

33. The method of claim 30, wherein:
a first subset of the plurality of Rx GBXs is dedicated to one or more traffic channel protocols of the one or more traffic channels, and
a second subset of the plurality of Rx GBXs is configurable for different traffic channel protocols of the one or more traffic channels.

34. The method of claim 33, wherein:
the first subset of the plurality of Rx GBXs is dedicated to the one or more traffic channel protocols based on priorities of the one or more traffic channel protocols, latency requirements of the one or more traffic channel protocols, bandwidth requirements of the one or more traffic channel protocols, or any combination thereof, and
the second subset of the plurality of Rx GBXs is configurable for the different traffic channel protocols based on priorities of the different traffic channel protocols, latency requirements of the different traffic channel protocols, bandwidth requirements of the different traffic channel protocols, or any combination thereof.

35. The method of claim 30, wherein:
each portion of the plurality of portions of the one or more traffic channels includes header information, and
the header information has a variable length based on a traffic channel protocol associated with the portion of the plurality of portions of the one or more traffic channels.

36. The method of claim 35, wherein:
the header information occupies fewer bits of the portion of the plurality of portions of the one or more traffic channels based on the traffic channel protocol being a higher bandwidth channel protocol and more bits based on the traffic channel protocol being a lower bandwidth channel protocol.

37. The method of claim 30, wherein each of the subset of receive D2D physical layer interfaces of the plurality of receive D2D physical layer interfaces is configured to receive at least the portion of the plurality of portions of the one or more traffic channels from a transmit D2D physical layer interface of a second component die.
